(19) United States
(12) Patent Application Publication
(10) Pub. No.: US 2014/0316871 A1
(43) Pub. Date: Oct. 23, 2014

(54) Tribrid Compensation Plan

(71) Applicants: Melyn Campbell, Salt Lake City, UT (US); Jack Petersen, Elk Ridge, UT (US)

(72) Inventors: Melyn Campbell, Salt Lake City, UT (US); Jack Petersen, Elk Ridge, UT (US)

(21) Appl. No.: 13/866,021

(22) Filed: Apr. 18, 2013

(51) Int. Cl. G06Q 30/02

(52) U.S. Cl. CPC G06Q 30/0214
USPC 705/14.16

(57) ABSTRACT

In a direct marketing environment, a compensation method for calculating compensation of a distributor entails utilizing multiple compensation systems in serial with each other, such that a first distributor of a direct marketing company may receive compensation under a first compensation system as well as compensation under one or more additional compensation systems, and wherein providing compensation under at least one of the compensation systems occurs without regard to whether compensation was provided under another compensation system.

### CROSS-REFERENCE TO RELATED APPLICATIONS

This application claims the benefit of U.S. Provisional Application No. 61/635,137, filed Apr. 18, 2012.

### BACKGROUND OF THE INVENTION

1. Field of the Invention

The present invention relates to direct marketing, and more particularly to systems and methods for compensation for direct marketing.

2. Background and Related Art

Globally in 2009, Direct Selling total sales totaled over $117 billion with 74 million sellers worldwide. The United States was the lead country in these statistics with $28.3 billion in sales and 16.1 million salespeople. According to industry statistics from dsa.org, the U.S. Direct Selling Association (DSA) has 203 member companies and 41 newcomer, pending-member companies. Clearly the MLM sales model for companies has had continued success.

As an MLM company grows and a network of distributors has been built, the goal becomes to keep as many distributors as possible, while still growing the company and the network. Independent distributors are just that, independent: they can sell/distribute any product for any company and build any network. Direct marketing companies have attempted numerous strategies to strengthen their distributor networks, prevent attrition, and maximize sales and profits. However, these strategies have shown challenges in creating net growth or in preventing net distributor attrition. Therefore, for these and other reasons, existing direct marketing companies and practices are limited in their ability to grow and to respond to competition.

### BRIEF SUMMARY OF THE INVENTION

Implementations of the invention provide systems, methods, and computer-readable media for providing systems and performing methods of calculating compensation of a distributor in a direct marketing environment. According to an implementation, a compensation method entails utilizing multiple compensation systems in serial with each other, such that a first distributor of a direct marketing company may receive compensation under a first compensation system as well as compensation under one or more additional compensation systems, and wherein providing compensation under at least one of the compensation systems occurs without regard to whether compensation was provided under another compensation system.

The multiple compensation systems may include three compensation plans. For example, the compensation plans may include a unilevel commissions compensation plan, a binary tree compensation plan, and an executive check match compensation plan. The first distributor's ability to receive compensation under each of the compensation plans may be dependent on satisfying certain personal activity requirements that vary according to the compensation plans. Additionally, the first distributor's ability to receive compensation under at least one of the compensation plans may be dependent on satisfying certain downline activity requirements.

In certain implementations, compensation under the unilevel compensation plan is calculated according to a level-by-level percentage commission of sales within a downline of the first distributor. The level-by-level percentage commission may vary according to the level of the first distributor's downline.

In some implementations, compensation under the binary tree compensation plan is calculated according to a total business volume of one branch of the first distributor's downline once distributors from at least two separate branches of the first distributor's downline have achieved a certain level of sales activity. Compensation under the binary tree compensation plan may be calculated according to a total business volume of the second largest total business volume of a branch of the first distributor's downline, wherein each branch for purposes of calculating the branch's total business volume must start with a different distributor on the same level of the downline.

In selected implementations, compensation under the executive check match compensation plan is calculated according to a percentage match of all compensation received by distributors in the first distributor's downline under the binary tree compensation plan.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system environment in which embodiments of the invention may be practiced;

FIG. 2 shows a representative networked computer system environment in which embodiments of the invention may be practiced;

FIG. 3 shows a representative direct marketing network; and

FIGS. 4-6 illustrate representative compensation plans.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods, and computer-readable media for providing systems and performing methods of calculating compensation of a distributor in a direct marketing environment. According to an embodiment, a compensation method entails utilizing multiple compensation systems in serial with each other, such that a first distributor of a direct marketing company may receive compensation under a first compensation system as well as compensation under one or more additional compensation systems, and wherein providing compensation under at least one of the compensation systems occurs without regard to whether compensation was provided under another compensation system.

The multiple compensation systems may include three compensation plans. For example, the compensation plans may include a unilevel commissions compensation plan, a binary tree compensation plan, and an executive check match compensation plan. The first distributor's ability to receive compensation under each of the compensation plans may be dependent on satisfying certain personal activity requirements that vary according to the compensation plans. Additionally, the first distributor's ability to receive compensation under at least one of the compensation plans may be dependent on satisfying certain downline activity requirements.

In certain embodiments, compensation under the unilevel compensation plan is calculated according to a level-by-level percentage commission of sales within a downline of the first distributor. The level-by-level percentage commission may vary according to the level of the first distributor's downline.

In some embodiments, compensation under the binary tree compensation plan is calculated according to a total business volume of one branch of the first distributor's downline once distributors from at least two separate branches of the first distributor's downline have achieved a certain level of sales activity. Compensation under the binary tree compensation plan may be calculated according to a total business volume of the second largest total business volume of a branch of the first distributor's downline, wherein each branch for purposes of calculating the branch's total business volume must start with a different distributor on the same level of the downline.

In selected embodiments, compensation under the executive check match compensation plan is calculated according to a percentage match of all compensation received by distributors in the first distributor's downline under the binary tree compensation plan.

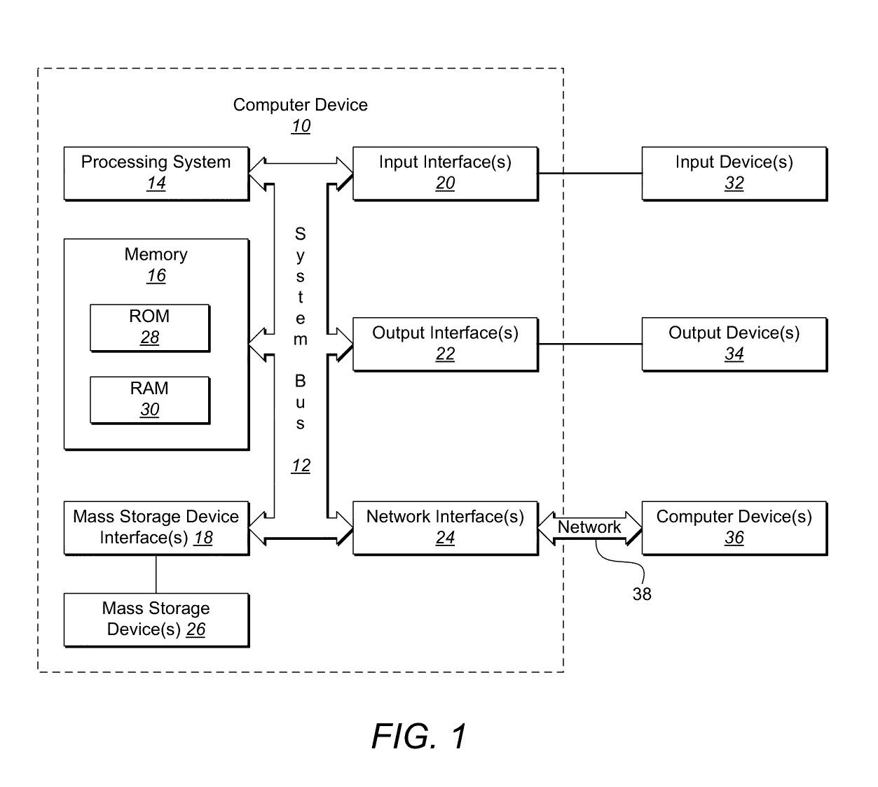

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

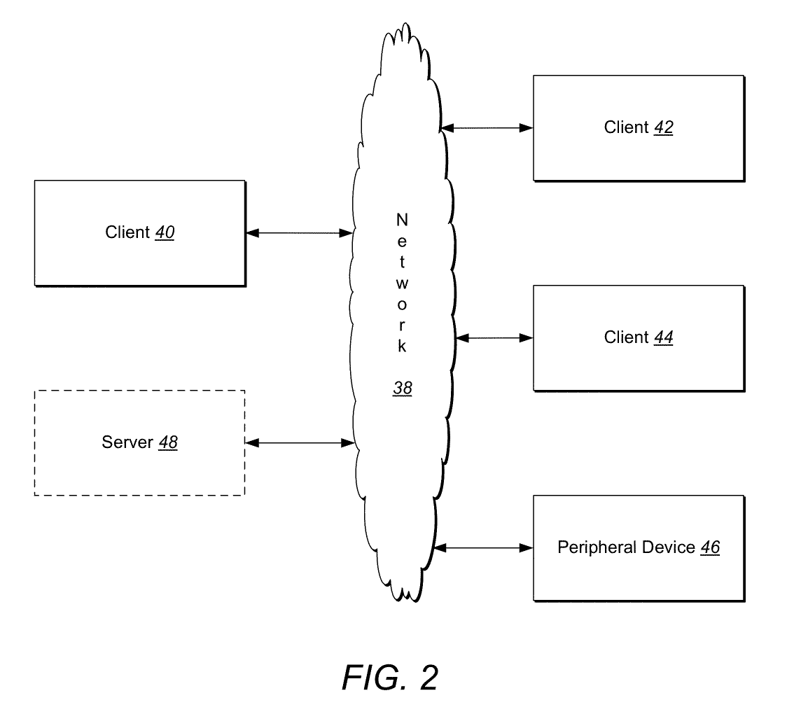

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

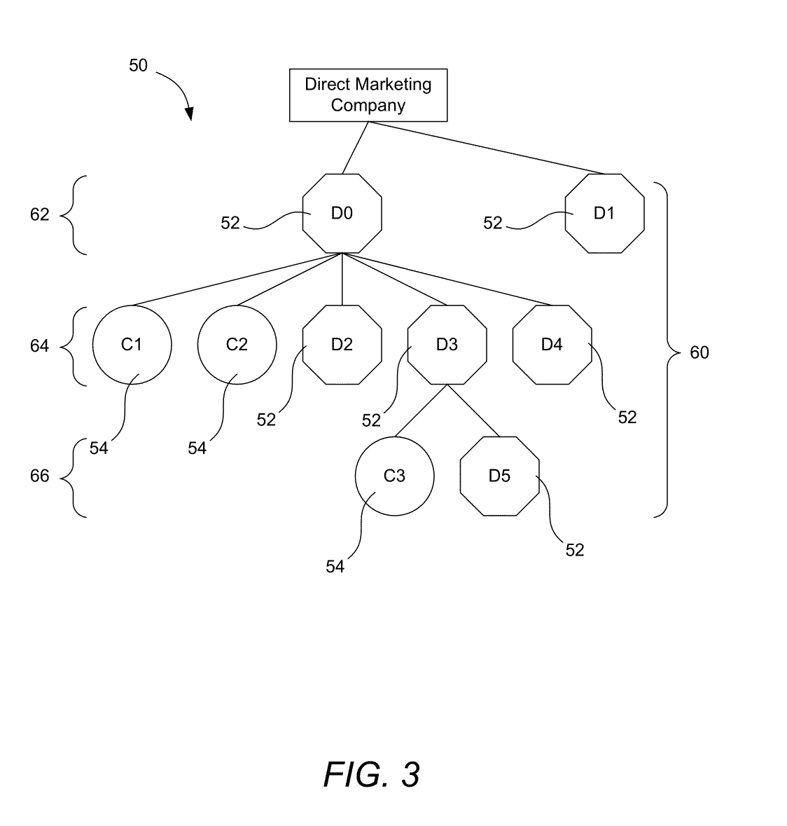

To illustrate how methods of compensation in accordance with embodiments of the invention might function, FIG. 3 a representative network marketing organization 50. FIG. 1 depicts a network marketing organization 20 that has six distributors 52 and three customers 54. For illustration purposes, the customers C1-C3 54 are depicted as circles, and distributors D0-D5 52 are depicted as octagons. It will be understood, that other embodiments can include more members in the network marketing organization 20 than are depicted in FIG. 3. For example, some network marketing organizations 20 can include hundreds or thousands of members, multiple distributors 52 in various levels, and many levels, such as up to dozens, hundreds, or thousands of levels in respective downlines 60. In the illustrated network, the downlines have three levels: level zero 62, level one 64, and level three 66.

Network marketing is a business model that combines direct retail marketing with a sales force of independent contractors. Network marketing is an alternate channel to traditional store-based retail sales and marketing. Network marketing businesses usually function by enrolling unsalaried distributors 52 to sell products. Distributors 52 may earn additional sales commissions based on the sales of people recruited into their downline 60. A distributor's downline 60 includes the distributor's direct recruits, recruits' recruits and so on such that there may be multiple levels 62, 64, 66 of people receiving commissions from one person's sales. Thus, as a distributor's downline 60 grows, the distributor 52 has increased earning abilities.

Accordingly, as shown in FIG. 3, a primary distributor 52, D0, has recruited two customers 54, C1 and C2, into his/her front line or first level 64. In some embodiments, customers recruited by a distributor 52 can be located on the recruiting distributor's frontline or first level 64, as shown. Distributor D0 has also recruited three additional distributors 52, D2-D5, into his front line. Downline distributor D2 has also recruited customer 54, C3, and distributor 52, D5, into his front line, which is level two 64 of D0's downline 60. Other distributors 52, such as distributor D1 may have their own downlines 60 as well.

Customers 54 can be individuals who buy products through a recruiting distributor 52. Some customers 54 can be retail customers who buy products with or without a purchasing commitment or quota. Enrolling distributors 52 can get a retail markup plus commissions on products sold to customers 54. Other customers 54 can be preferred customers who purchase products on a subscription basis in return for a product price without the retain markup. Some preferred customers may be auto-ship customers, which automatically purchase and receive a certain amount of product from the network marketing organization 50 monthly, quarterly, annually or otherwise periodically.

In some embodiments, when customers 52 and/or distributors 54 purchase products from the network marketing organization 50, the purchases are made through the recruiting distributor 52 and/or are attributed to the recruiting distributor. Thus, a compensation system of the network marketing organization 50 can be configured to recognize who purchased each product, and where the purchaser is positioned in the network marketing organization 50. In this way, the appropriate upline distributor(s) 52 can be identified, credited, and ultimately compensated for purchases made by distributors 52 and customers 54 in his or her downline 60.

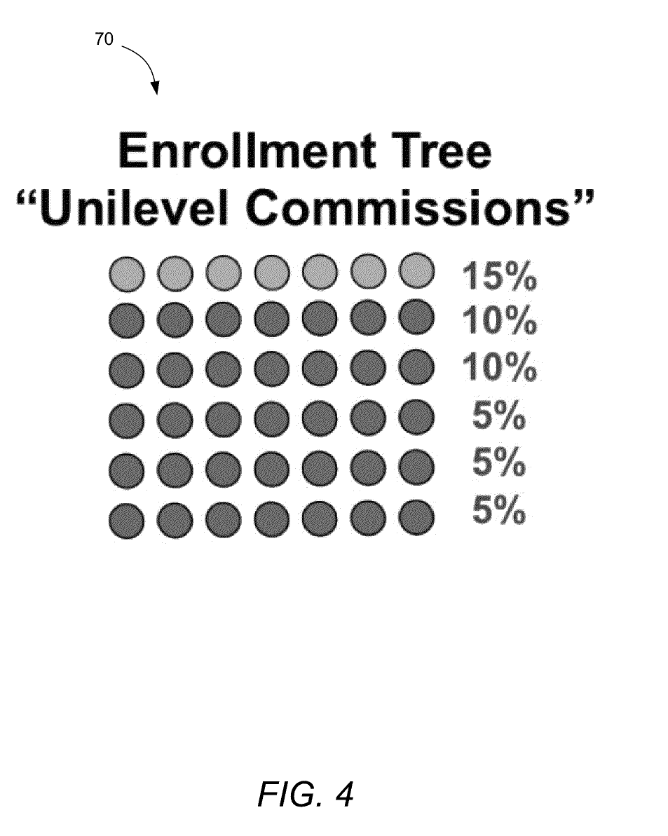

While a traditional direct marketing company typically is limited to a single compensation mechanism or method for its distributors 52, such a method fails to encourage distributors 52 to maximize their own activities and the activities of distributors 52 in their downlines 60. According to embodiments of the invention, distributors 52 are encouraged to maximize their own sales, distribution, and recruitment activities, as well as the sales, distribution, and recruitment activities of the distributors 52 in their downlines 60 by utilizing multiple compensation system and methods in conjunction with each other. FIGS. 4-6 illustrate exemplary direct marketing compensation methods that may be used in conjunction with one another.

FIG. 4 illustrates a basic unilevel commissions compensation plan 70 that can be used or modified for use with embodiments of the invention. The unilevel commissions compensation plan 70 provides compensation to a distributor 52 determined strictly on commissions based on sales activities of the distributor 52 as well as sales activities of distributors 52 in the first distributor's downline 60. The percentage of commission can be varied by level, and receipt of payments according to the unilevel commissions compensation plan 70 may be contingent upon certain factors, such as on the first distributor 52 achieving a certain level of personal volume (PV), upon a certain number of distributors 52 within the first distributor's downline 60 achieving certain PV requirements, or any other desired metric. PV may be understood to be product purchased at wholesale from the company in a given period of time (e.g. month, week) by that distributor 52 either for resale to the distributor's customers 54 or for personal use.

Once any requirements for participation in the unilevel commissions compensation plan 70 are satisfied, the first distributor 52 receives commissions according to sales of the distributor 52 as well as distributors in his or her downline 60, according to how many levels removed the distributors 52 are in the downline 60. FIG. 4 illustrates a non-limiting example of commission percentages that might be applied to sales within the distributor's downline. Of course, the exact percentages could be varied from example to example while still falling within the spirit of embodiments of the invention. In FIG. 4, the distributor 52 receives 15% commissions on the distributor's own personal sales (e.g. level zero 62), 10% commissions on sales of all distributors 52 personally recruited by the first distributor 52 (e.g. level one 64), 10% commissions on sales of all distributors 52 recruited by distributors 52 in level one 64 (e.g. level two 66), and 5% commissions on sales of all distributors 52 in the next three levels of the downline 60. Under the unilevel commissions compensation plan 70, the distributor 52 thus benefits not only from his or her own sales activities, but also from his or her recruitment activities and the sales and recruitment activities of his or her downline 60.

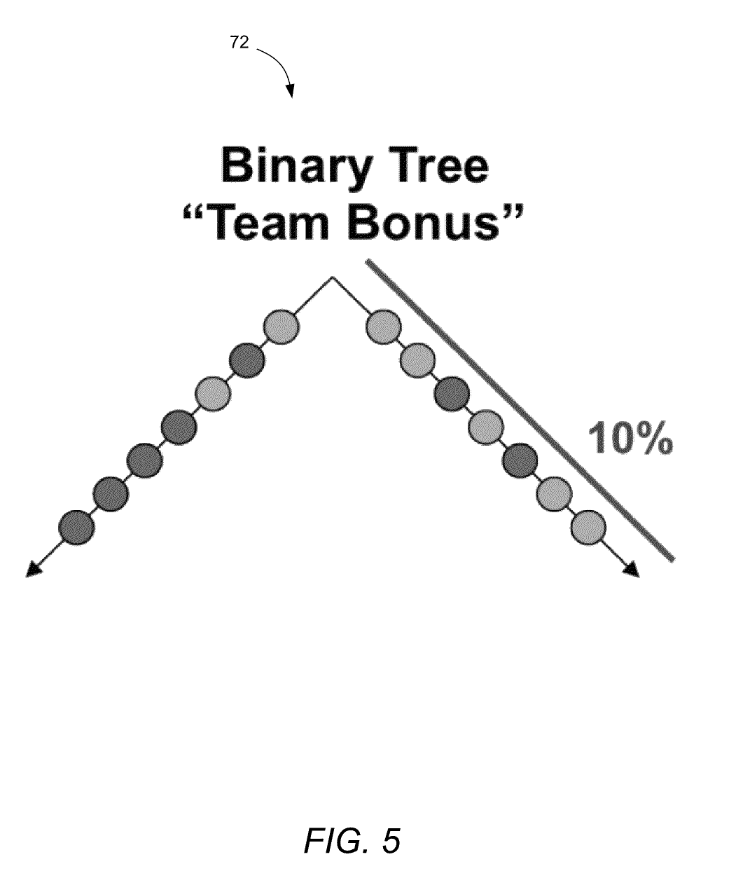

FIG. 5 illustrates a binary tree “team bonus” compensation plan 72 that may be used or modified for use with embodiments of the invention. The binary tree compensation plan 72 provides compensation to a distributor 52 determined on obtaining certain levels of achievement of both the first distributor 52 as well as distributors 52 within the first distributor's downline 60. For example, compensation under the binary tree compensation plan 72 may only be available to the first distributor 52 upon the first distributor's achievement of a certain level of PV, which may exceed the amount of PV necessary to participate in the unilevel commissions compensation plan 70 when the two plans are used or made available together. A distributor 52 achieving such a level of PV might be deemed an “active distributor.”

Once any personal requirements for participation in the binary tree compensation plan 72 are satisfied, the first distributor 52 receives compensation under the binary tree compensation plan 72 in a manner that is designed to motivate the first distributor 52 to mentor and motivate distributors 52 in his or her downline 60. One way that the first distributor 52 may be motivated to mentor distributors 52 in his or her downline 60 is by placing limits on when compensation is available under the binary tree compensation plan 72. For example, compensation under the binary tree compensation plan 72 may only be made available to the first distributor 72 when at least two distributors 52 in different main branches of the first distributor's downline 60 are active distributors (e.g. have sufficient PV to qualify themselves personally to participate in the binary tree compensation plan 72), or by some other metric. Thus, the first distributor 72 will be motivated and encouraged to mentor and motivate distributors 52 in his or her downline 60 to reach certain levels of participation and/or achievement.

In this example, if the first distributor 52 and his or her downline 60 satisfies these requirements, the first distributor becomes eligible to participate in the binary tree compensation plan 72 and to receive a team bonus. The team bonus may be calculated or determined to further motivate the first distributor 52 to participate in mentoring and motivating distributors 52 in his or her downline 60. For example, the team bonus may be calculated as a certain percentage (e.g. 10% as illustrated in FIG. 5) of the team business volume (TBV) of one of the legs of the distributor's downline 60. To encourage the first distributor 52 to focus his motivation and mentoring efforts on his or her entire downline 60, the leg of the distributor's downline 60 selected for calculating the team bonus may be the leg with the lesser TBV.

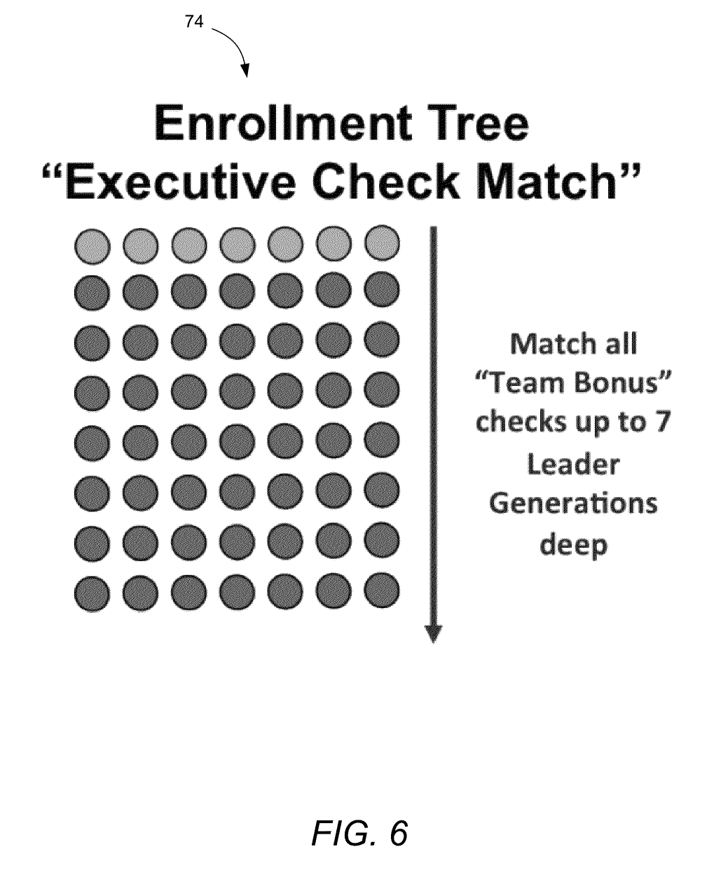

In this fashion, the first distributor 52 will be motivated to encourage, teach, mentor, and motivate various of the distributors 52 in his or her downline 60, because to participate in the binary tree compensation plan 72 and receive a strong team bonus, the first distributor 52 must help multiple of his or her downline distributors 52 in multiple different branches to be active distributors, and cannot focus his or her efforts on a single branch of the downline 60 or have only a minimal team bonus. For purposes of the binary tree compensation plan 72, the TBV may be calculated according to any desired method of calculation. By way of one example, the TBV may be calculated as all volume attributed to the branch of the downline 60. As another example, the TBV may be calculated as all volume attributed to the branch of the downline 60 that exceeds each distributor's minimum participatory volume under the unilevel commissions compensation plan 70. As another example, the TBV may be calculated as all volume attributed to the branch of the downline 60 that exceeds each distributor's minimum participatory volume under the unilevel commissions compensation plan 70 and that also excludes any volume compensable under a third compensation method, the executive check match compensation plan 74, discussed below with respect to FIG. 6.

While the binary tree compensation plan 74 may be designed to motivate the first distributor 52 and all other distributors 52 to more actively manage, motivate, encourage, mentor, train, etc. their downlines 60, the binary tree compensation plan 74 may not be sufficient to cause the distributors 52 to do as much as they can to maximize the potential of their downlines 60. FIG. 6 illustrates the executive check match compensation plan 74 and illustrates how this third compensation plan may be used to encourage distributors 52 to do all they can to maximize their downlines' potentials. As with the unilevel commissions compensation plan 70 and the binary tree compensation plan 72, the executive check match compensation plan 74 provides compensation to the first distributor 52 determined on obtaining even greater levels of achievement of both the first distributor 52 as well as distributors 52 within the first distributor's downline 60. For example, compensation under the executive check match compensation plan 74 may only be available to the first distributor 52 upon the first distributor's achievement of a certain even-higher level of PV, which may exceed the amount of PV necessary to participate in the unilevel commissions compensation plan 70 or the binary tree compensation plan 72 when the three plans are used or made available together. A distributor 52 achieving such a level of PV might be deemed an “executive distributor.”

Once any personal requirements for participation in the executive check match compensation plan 74 are satisfied, the first distributor 52 receives compensation under the executive check match compensation plan 74 in a manner that is designed to motivate the first distributor 52 to cause the distributors 52 in his or her downline 60 to mentor and motivate distributors 52 in their own downlines 60. This motivation may be provided by allowing an executive distributor to receive an enrollment tree percentage match on all team bonuses provided to distributors 52 within a certain number of levels of the executive distributor's downline 60. Thus, as more of the distributors 52 in the executive distributor's downline 60 qualify to receive team bonuses under the binary tree compensation plan 72, the executive distributor's compensation under the executive check match compensation plan 74 increases. Thus the executive distributor benefits by having a highly effective, active, and motivated downline 60.

As discussed the executive distributor may receive a percentage bonus based on all team bonuses paid to distributors 52 in his or her downline 60 to a certain level. In the example illustrated in FIG. 6, the executive distributor receives a percentage bonus through seven levels of his or her downline 60. In other examples, the number of levels may of course be varied to achieve the desired participatory effect. In some instances, the percentage bonus may be calculated in a flat manner such that the executive distributor receives a flat percentage of all team bonuses through the given number of levels of his or her downline 60. In other instances, the percentage bonus may be calculated as a varying percentage of team bonuses depending on how many levels down the downline 60 the participating distributor 52 is located who received the team bonus. Of course, other calculations and limitations may be in place to further modify the bonus received under the executive check match compensation plan 74.

Participation in or receiving compensation from any of the various compensation plans may be limited in any of a variety of ways to encourage both personal activity by the distributors 52 and downline mentoring and monitoring activity by the distributors 52. As discussed above, increasing limits based on personal activity may limit distributors' ability to participate in the increasing benefits of the various compensation plans, so as to ensure that the distributors 52 remain personally dedicated to the company's products and their own recruited customers 54. Of course, distributors 52 may determine that the benefits of participation may be so high as to warrant simply satisfying PV requirements by purchasing product, whether or not such product is successfully distributed to customers 54 or personally used. Either way, the direct marketing company obtains the benefit of increased sales. Additionally, in some instances, the direct marketing company may require that distributors 52 wishing to participate in one, two, or all of the compensation plans must pay a membership fee to help the distributors 52 recognize their investment in the success of the direct marketing company and to add a further revenue stream to the direct marketing company.

Compensation according to the various compensation plans may also be tiered according to levels of personal and downline success to encourage distributors 52 to reach to the next level of success and achieve higher levels of compensation. For example, a percentage under a certain compensation plan may be increased when a certain level of activity and volume has been reached, such as beyond a minimum level required to qualify under the respective compensation plan. Other bonuses and motivators may be provided in similar fashion.

The attached appendix provides a specific example of a full compensation plan including a version of the unilevel commissions compensation plan 70, a version of the binary tree compensation plan 72, and a version of the executive check match compensation plan 74. The example provided in the appendix is not intended to be limiting, but is intended to illustrate the various details of a possible plan to more fully flesh out the specifics of how the various compensation plans might function. Additionally, while a version of the unilevel commissions compensation plan 70, a version of the binary tree compensation plan 72, and a version of the executive check match compensation plan 74 are discussed as examples of multiple compensation plans used with each other to compensate a distributor 52 within a direct marketing environment, they are examples only, and other compensation plans could be used in conjunction with one or all of the illustrative compensation plans, or other compensation plans could be used with each other without being used in conjunction with any of the specific examples of compensation plans discussed herein.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method of calculating compensation of a distributor in a direct marketing environment comprising:
utilizing multiple compensation systems in serial with each other, such that a first distributor of a direct marketing company may receive compensation under a first compensation system as well as compensation under one or more additional compensation systems, and wherein providing compensation under at least one of the compensation systems occurs without regard to whether compensation was provided under another compensation system.

2. A method as recited in claim 1, wherein the multiple compensation systems comprise three compensation plans.

3. A method as recited in claim 2, wherein the compensation plans comprise:
a unilevel commissions compensation plan;
a binary tree compensation plan; and
an executive check match compensation plan.

4. A method as recited in claim 3, wherein the first distributor's ability to receive compensation under each of the compensation plans is dependent on satisfying certain personal activity requirements that vary according to the compensation plans.

5. A method as recited in claim 4, wherein the first distributor's ability to receive compensation under at least one of the compensation plans is dependent on satisfying certain downline activity requirements.

6. A method as recited in claim 3, wherein compensation under the unilevel compensation plan is calculated according to a level-by-level percentage commission of sales within a downline of the first distributor.

7. A method as recited in claim 6, wherein the level-by-level percentage commission varies according to the level of the first distributor's downline.

8. A method as recited in claim 3, wherein compensation under the binary tree compensation plan is calculated according to a total business volume of one branch of the first distributor's downline once distributors from at least two separate branches of the first distributor's downline have achieved a certain level of sales activity.

9. A method as recited in claim 8, wherein compensation under the binary tree compensation plan is calculated according to a total business volume of the second largest total business volume of a branch of the first distributor's downline, wherein each branch for purposes of calculating the branch's total business volume must start with a different distributor on the same level of the downline.

10. A method as recited in claim 8, wherein compensation under the executive check match compensation plan is calculated according to a percentage match of all compensation received by distributors in the first distributor's downline under the binary tree compensation plan.

11. A non-transitory computer-readable medium containing computer program code to cause a computer to execute a method of calculating compensation of a distributor in a direct marketing environment, the method comprising:
utilizing multiple compensation systems in serial with each other, such that a first distributor of a direct marketing company may receive compensation under a first compensation system as well as compensation under one or more additional compensation systems, and wherein providing compensation under at least one of the compensation systems occurs without regard to whether compensation was provided under another compensation system.

12. A non-transitory computer-readable medium as recited in claim 11, wherein the multiple compensation systems comprise three compensation plans.

13. A non-transitory computer-readable medium as recited in claim 12, wherein the compensation plans comprise:
a unilevel commissions compensation plan;
a binary tree compensation plan; and
an executive check match compensation plan.

14. A non-transitory computer-readable medium as recited in claim 13, wherein the first distributor's ability to receive compensation under each of the compensation plans is dependent on satisfying certain personal activity requirements that vary according to the compensation plans.

15. A non-transitory computer-readable medium as recited in claim 14, wherein the first distributor's ability to receive compensation under at least one of the compensation plans is dependent on satisfying certain downline activity requirements.

16. A non-transitory computer-readable medium as recited in claim 13, wherein compensation under the unilevel compensation plan is calculated according to a level-by-level percentage commission of sales within a downline of the first distributor.

17. A non-transitory computer-readable medium as recited in claim 16, wherein the level-by-level percentage commission varies according to the level of the first distributor's downline.

18. A non-transitory computer-readable medium as recited in claim 13, wherein compensation under the binary tree compensation plan is calculated according to a total business volume of one branch of the first distributor's downline once distributors from at least two separate branches of the first distributor's downline have achieved a certain level of sales activity.

19. A non-transitory computer-readable medium as recited in claim 18, wherein compensation under the binary tree compensation plan is calculated according to a total business volume of the second largest total business volume of a branch of the first distributor's downline, wherein each branch for purposes of calculating the branch's total business volume must start with a different distributor on the same level of the downline.

20. A non-transitory computer-readable medium as recited in claim 18, wherein compensation under the executive check match compensation plan is calculated according to a percentage match of all compensation received by distributors in the first distributor's downline under the binary tree compensation plan.
